(19) United States
(12) Patent Application Publication
(10) Pub. No.: US 2024/0084175 A1
(43) Pub. Date: Mar. 14, 2024

(54) PRESSURE-SENSITIVE PVC COVER STRIP

(71) Applicant: Carlisle Intangible, LLC, Scottsdale, AR (US)

(72) Inventor: Michael J. Scanish, Camp Hill, PA (US)

(21) Appl. No.: 18/519,928

(22) Filed: Nov. 27, 2023

Related U.S. Application Data
(63) Continuation of application No. 16/983,104, filed on Aug. 3, 2020, now Pat. No. 11,827,813.
Application No. 16/983,104 is a continuation of application No. 15/992,475, filed on May 30, 2018, now Pat. No. 10,731,057.
(60) Provisional application No. 62/514,173, filed on Jun. 2, 2017.

(51) Int. Cl. C09J 7/50; B32B 27/22; B32B 27/30; C09J 7/24; C09J 7/29; C09J 7/38; C09J 7/40; E04D 5/10

(52) U.S. Cl. CPC C09J 7/50; B32B 27/22; B32B 27/304; C09J 7/245; C09J 7/29; C09J 7/383; C09J 7/401; E04D 5/10; C09J 123/22; C09J 2413/001

(57) ABSTRACT

A PVC-based cover strip designed to bond to non-PVC materials as well as PVC materials includes a PVC layer coated with a barrier effective to prevent migration of plasticizers from the PVC layer. The barrier layer, in turn, is coated with a primer and subsequently a pressure-sensitive adhesive. The barrier layer is generally a polar polymer, such as acrylonitrile rubber which resists migration of phthalate plasticizers. The pressure-sensitive adhesive layer is a pressure-sensitive adhesive suitable for use in roofing applications.

### CROSS-REFERENCE TO RELATED APPLICATION

This application claims the benefit of U.S. patent application Ser. No. 16/983,104, now U.S. Pat. No. 11,827,813, filed Aug. 3, 2020, which claims the benefit of U.S. patent application Ser. No. 15/992,475, filed May 30, 2018, now U.S. Pat. No. 10,731,057, which claims priority to U.S. Patent Application No. 62/514,173 filed on Jun. 2, 2017, each of which is expressly incorporated by reference herein in their entirety.

### BACKGROUND OF THE INVENTION

In the roofing industry, cover strips are often used to bond two materials together, such as edge strips and roofing membranes. Typically, these are a 6-9 inches wide membrane strips coated with a pressure-sensitive adhesive layer. Traditional PVC roofing membranes contain a liquid phthalate plasticizer that will attack many traditional pressure-sensitive (PS) adhesives in the roofing market. Currently, no manufacturer supplies a PS cover strip product for PVC roofs. This is problematic for dealing with edge metal. Currently all edge metal used with PVC membrane roofs must be PVC coated to allow for non-PS PVC Flashing to be welded to the metal as well as the PVC roofing membrane. This limits the colors available for the metal. Finally, currently there is no easy way to tie-in a PVC roofing membrane to either EPDM or TPO membranes without a curb between the two membranes.

### SUMMARY OF THE INVENTION

This invention provides a system of primers and PS adhesive that allows for a PS PVC cover strip to be produced which will adhere to a variety of substrates including PVC and KEE PVC membranes, metal edging, EPDM and TPO roofing membranes. The proposed construction of the PS PVC cover strip utilizes a series of primers that allow for a common roofing PS adhesive to be used with the PVC membranes. The first primer provides a layer of high plasticizer resistance. This prevents the plasticizer from the PVC membrane from attacking the PS adhesive. The second primer prepares the PVC surface for adhesion of the PS adhesive. The PS adhesive must be of significant construction to allow for conformation to step-offs, long-term performance, resistant to standing water and compatible with other common single-ply roofing materials.

### BRIEF DESCRIPTION OF THE DRAWINGS

FIG. 1 is cross-sectional view of a cover strip according to the present invention;

FIG. 2 is a cross-sectional view of the cover strip of the present invention for use with an edge termination; and

FIG. 3 is a cross-sectional view partially exploded, showing the application of the cover strip to a PVC membrane and a non-PVC membrane.

### DETAILED DESCRIPTION OF THE INVENTION

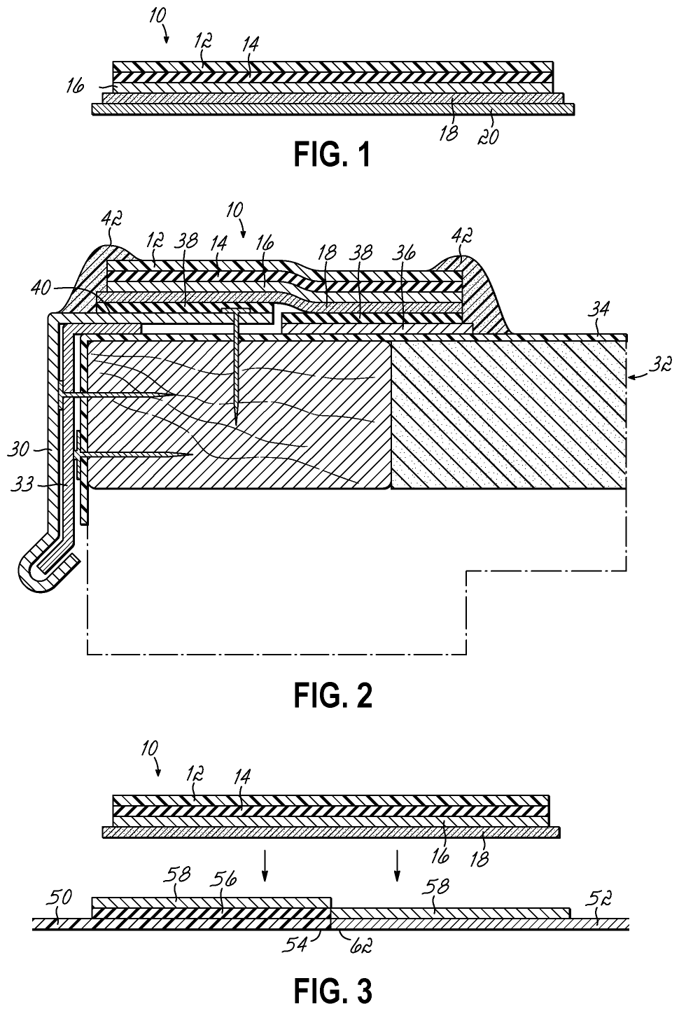

As shown in FIG. 1, the present invention is a cover strip 10 which incorporates an upper PVC layer 12 of the type typically used in roofing applications, generally about 60 mils thick. The bottom surface of the PVC layer 12 is coated with a barrier layer 14 which prevents migration of plasticizers from the PVC layer 12. In turn, the barrier layer 14 is coated with a primer layer 16 which is in turn coated with a pressure-sensitive (PS) adhesive layer 18. Finally, the PS layer is covered with the silicone-coated release sheet 22. The cover strip will be 6-12 inches wide, typically 6-9 inches wide.

The barrier layer 14 is a layer that prevents migration of phthalate type plasticizers typically employed in PVC membranes. Generally, the barrier layer will be a polar polymer. One such polar polymer suitable for use in the present invention is an acrylonitrile rubber or NBR which is applied directly to the surface and PVC and allowed to set. Generally, this will be 0.167 mils to 2.5 mils thick.

The composition of the primer will be determined by the composition of the pressure-sensitive adhesive. Generally, the primer will be 0.2 mils to 0.6 mils thick. The pressure-sensitive adhesive can be any pressure-sensitive adhesive typically used in roofing applications such as bromobutyl rubber, pressure-sensitive adhesive and the like. Other suitable pressure-sensitive adhesives may be based on butyl, polyisobutylene, halobutyl, or other suitable polymers. The primer will generally be of a similar composition but with reduced solids content. The primer is simply applied to the barrier layer 14 and allowed to set. Then the pressure-sensitive adhesive layer 18 and release sheet 22 are laminated to the primer layer 16.

FIG. 2 shows the use of the present invention to apply a rigid edge member 30 to a roof surface 32 which is covered with a PVC membrane 34. In this application, the PVC membrane 34 is applied to the roof 32 as would be typically done during the roofing application. A connector strip 33 is nailed to a corner of roof 32. The edge termination strip 30 engages to connector strip 33 at one edge and is nailed to the roof 32, trapping the PVC membrane between the roof surface and the edge treatment 30. The edge treatment 30 in this application is not coated with a PVC coating, but rather may be a painted metal surface or the like. Basically, in this application, any non-PVC coated edge treatment can be used.

The cover strip 10 is applied over the edge treatment 30 and over the PVC membrane 34. A strip barrier coating 36 which is generally the same as barrier coating 14 and a primer coating 38 (again the same as primer coating 16 in FIG. 1) are applied to PVC membrane 34. The release sheet 22 is removed from the cover strip 10 and the cover strip 10 applied over the barrier and primer-coated portion of the PVC 34 and directly onto the upper surface 40 of edge treatment 30. Sealants 42 can be applied at either edge of the cover strip 10 to provide a further water barrier but are not necessary. The pressure sensitive-adhesive layer 18 will bond directly to surface 40 of the edge treatment using primer layer 38 and further bonds to the PVC 34, which is coated with a separate barrier layer 36 and separate primer layer 38.

FIG. 3 shows an alternate use of the present invention in which the cover strip 10 is used to bond a PVC membrane 50 to a non-PVC membrane 52, such as TPO, EPDM or the like. The edge 54 of the PVC membrane 50 is first coated with a strip of barrier layer 56 and subsequently a primer layer 58. The non-PVC membrane 52 does not require a barrier layer, as it does not include plasticizers. But a strip of primer 58 is applied to the edge 62 of membrane 52 to improve adhesion to the PSA. The cover strip 10 is simply applied directly to the edge portions of the two membranes. The pressure-sensitive adhesive 18 will bind to the primer layer 58 on the PVC layer and bond directly to the surface of the non-PVC membrane 52. Further the pressure-sensitive adhesive on the cover strip is protected from the plasticizers present in the PVC. Further, no welding is required to form any bonds.

This has been a description of the present invention, along with the preferred method of practicing the present invention. The invention itself, however, should be defined only by the appended claims wherein we claim:

What is claimed is:

1. A PVC cover strip for sealing a transition to a PVC membrane on a roof, the PVC cover strip comprising:
a PVC layer having a first surface and a second surface and defining opposing edges across a width, the first surface configured to be exposed to weather;
a barrier layer coating the second surface, the barrier layer being effective to prevent chemical migration from the PVC layer from passing through the barrier layer;
a primer layer coating the barrier layer; and
a pressure-sensitive adhesive layer coating the primer layer and extending from one edge of the PVC layer to the opposing edge of the PVC layer across the width.

2. The cover strip of claim 1 wherein the primer layer is bromobutyl rubber or is based on at least one of butyl, polyisobutylene, or halobutyl polymers with reduced solids content relative to pressure sensitive adhesive layer.

3. The cover strip of claim 1 wherein the pressure sensitive adhesive is bromobutyl rubber or based on at least one of butyl, polyisobutylene, or halobutyl polymers.

4. The cover strip of claim 3 wherein the primer layer is a composition of the pressure sensitive adhesive layer but with a reduced solids content.

5. The cover strip of claim 1 wherein the barrier layer is effect to prevent plasticizer migration.

6. The cover strip of claim 1 wherein the barrier layer is a polar polymer.

7. The cover strip of claim 1 wherein the pressure sensitive adhesive is bromobutyl rubber.

8. An edge treatment for a roof comprising the PVC cover strip of claim 1.

9. A PVC cover strip for sealing a metal facia strip secured to a PVC membrane on a roof creating a step-off from the metal facia strip to the PVC membrane, the PVC cover strip comprising:
a PVC layer having a first surface and a second surface and defining opposing edges across a width, the first surface configured to be exposed to weather;
a barrier layer coating the second surface, the barrier layer being effective to prevent chemical migration from the PVC layer from passing through the barrier layer;
a primer layer coating the barrier layer; and
a pressure-sensitive adhesive layer coating the primer layer and extending between opposing edges a distance sufficient to span the step-off and to be bondable to each of the metal facia strip and to the PVC membrane.

10. The cover strip of claim 9 wherein the primer layer is bromobutyl rubber or is based on at least one of butyl, polyisobutylene, or halobutyl polymers with reduced solids content relative to pressure sensitive adhesive layer.

11. The cover strip of claim 9 wherein the pressure sensitive adhesive is bromobutyl rubber or based on at least one of butyl, polyisobutylene, or halobutyl polymers.

12. The cover strip of claim 11 wherein the primer layer is a composition of the pressure sensitive adhesive layer but with a reduced solids content.

13. The cover strip of claim 12 wherein the barrier layer is acrylonitrile rubber.

14. A method of manufacturing a PVC cover strip comprising:
applying a barrier layer of an acrylonitrile rubber to a PVC layer having a first surface and a second surface and defining opposing edges across a width, the first surface configured to be exposed to weather; the barrier layer coating the second surface;
allowing the barrier layer to set;
coating the set barrier layer with a primer layer;
allowing the primer layer to set; and
laminating the set primer layer with a pressure-sensitive adhesive layer and a release sheet,
wherein following laminating, the pressure-sensitive adhesive layer extends from one edge of the PVC layer to an opposing edge of the PVC layer across the width.

15. The method of claim 14 wherein the cover strip is 6 inches to 12 inches wide and wherein, following laminating, the primer layer extends from the one edge to the opposing edge of the PVC layer.

16. The method of claim 15 wherein applying the barrier layer includes providing a thickness effective to prevent plasticizer migration.

17. The method of claim 14 wherein coating includes coating with the primer layer that is bromobutyl rubber or is based on at least one of butyl, polyisobutylene, or halobutyl polymers with reduced solids content relative to pressure sensitive adhesive layer.

18. The method of claim 14 wherein laminating includes laminating the set primer layer with the pressure sensitive adhesive layer that is bromobutyl rubber or is based on at least one of butyl, polyisobutylene, or halobutyl polymers.

19. The method of claim 14 wherein following laminating, the primer layer is a composition of the pressure sensitive adhesive layer but with a reduced solids content.
